(19) United States
(12) Patent Application Publication
(10) Pub. No.: US 2026/0359028 A1
(43) Pub. Date: Nov. 12, 2026

(54) SYSTEM AND METHOD FOR DISTRIBUTED COORDINATION FOR AUTOMATIC SYSTEM UPGRADES

(71) Applicant: Absolute Software Corporation, Vancouver (CA)

(72) Inventor: Michael SNYDER, Seattle, WA (US)

(21) Appl. No.: 19/092,726

(22) Filed: Mar. 27, 2025

(51) Int. Cl. G06F 8/65; G06F 11/20

(52) U.S. Cl. CPC G06F 8/65; G06F 11/2007; G06F 2201/85

(57) ABSTRACT

The application pertains to a system and method of automatically updating servers in a network of servers comprising a plurality of servers configured to communicate with each other. The method comprising the steps of: a first server of the plurality of servers using a processer to determine if upgrades are available, the first server communicating with the other servers in the plurality of servers to determine if at least one of the other servers are online, the first server querying the other servers to determine if prerequisites are met, and if there are other servers online, the first server going offline to install updates. When the update to the first server is complete, the first server returns online; and the steps are repeated for each server in the network of servers.

### FIELD OF THE INVENTION

The description pertains to a system and method for distributed coordination for automatic system upgrades in a server pool. More specifically, the description pertains to a system and method for distributed coordination for automatic system upgrades in a server pool without a coordination server.

### DESCRIPTION OF THE PRIOR ART

In many business environments, server pools are used to allow users to connect to commonly shared programs and materials. A server pool comprises a plurality of servers which are interconnected and allow user to digitally connect thereto. When a user connects to a server pool, they are connecting to one of the plurality of servers within the pool. If the server to which they are connected needs to go offline, for example, to update its software of binaries, the user is kicked off the server and forced to connect to another server within the server pool. This is known as “failing over”. When a user is failed over, they are disconnected from the server pool temporarily which causes a disruption in their workflow. Furthermore, if the server pool is being updated, it is possible that a user is failed over from a first server to a second server to allow the first server to be updated and then, shortly thereafter is failed over when the second server needs to be updated. This causes multiple disruptions to the user.

FIG. 1 depicts a system of a server pool as known in the art. Each server withing the server pool (servers 1, 2 to server n) are in communication with a coordination server. A plurality of users (Users 1 to n) are connected to servers within the server pool. When the server requires an update, the coordination server manages which servers update and in what order. The coordination server will start with a server (commonly server 1), fail over any users connected to the server to another server, take server 1 offline, then update the server. Once this server is updated, the coordination server will put the server back online and repeat the process with the other servers in the server pool until all servers are updated. This process is slow, cumbersome and requires an extra coordination server to complete updates. It also often requires human intervention to initiate the process. This method completely disregards any disruptions that a user may experience as a result of the updates. A more efficient method is required.

### SUMMARY OF THE INVENTION

One embodiment pertains to a method of automatically updating servers in a network of servers, the network of servers comprising a plurality of servers configured to communicate with each other, and the method comprising the steps of:
a) a first server of the plurality of servers using a processer to determine if upgrades are available;
b) the first server communicating with the other servers in the plurality of servers to determine if at least one of the other servers are online;
c) the first server querying the other servers to determine if prerequisites are met;
d) if there are other servers online, the first server going offline to install updates;
e) when the update to the first server is complete, the first server returning online; and repeating steps a to d for each server in the network of servers.

In a further embodiment, each server in the network of servers is completing the method in parallel.

In yet a further embodiment, each of the servers in the network of servers waits a random amount of time within a predetermined time window to determine if upgrades are available.

In yet a further embodiment, before the step of the first server going offline, any users on the first server are requested to disconnect and reconnect to a second server in the network of servers.

In yet a further embodiment, a predetermined period of time is passed before requesting any users on the first server to reconnect to a second server.

In yet a further embodiment, in step c, if other servers are online, new users are prohibited from joining the first server.

In yet a further embodiment, before the step of the first server going offline, the first server communicates with the plurality servers and receiving the capacity of each server in the network of servers. The first server calculates the total capacity of the servers in the network by summing the capacity of each server in the network and compares the total capacity to the number of active users on the first server. If the number of active users on the first servers is less than the total excess pool capacity, the first server stops accepting new connections, allowing active users to naturally disconnect from the server. It does this by switching its mode to offline. If users don't naturally migrate to other servers soon enough, it sends a message to clients causing the active users on the first server to fail over to one of the plurality of servers in the network.

In yet a further embodiment, the first server is a first block of servers.

Another embodiment pertains to a server for use in a network of servers, the server having a communication console configured to communicate with a plurality of servers in the network of servers to send and receive the status, and capacity of each of the plurality of servers, and the program version run by each of the plurality of servers. The server further comprises a processer to access a manifest to determine if new binaries are available, using the status and capacity of each server in the plurality of servers determines if there is enough capacity in servers which are online to fail active users on the server over to one or more of the plurality of servers. The processer fails over the active users to one or more of the plurality of servers and the processer takes the server offline and updates the binaries. When the update to the server is complete, the processor returning the server to an online status.

Another embodiment pertains to a network of servers, the plurality of servers being connected in a network of servers, each having a communication console configured to communicate with the plurality of servers in the network of servers to send and receive the status, and capacity of each of the plurality of servers, and the program version run by each of the plurality of servers. Each of the plurality of servers further comprises a processer to access a manifest to determine if new binaries are available; using the status and capacity of each server in the plurality of servers, determine if there is enough capacity in servers which are online to fail active users on the server over to one or more of the plurality of servers. The processer fails over the active users to one or more of the plurality of servers and takes the server offline to update the binaries. When the update to the server is complete, the processor returns the server to an online status.

### BRIEF DESCRIPTION OF THE DRAWINGS

The features of the invention will become more apparent in the following detailed description in which reference is made to the appended drawings wherein:

FIG. 1 is a system for updating a server pool as known in the prior art;

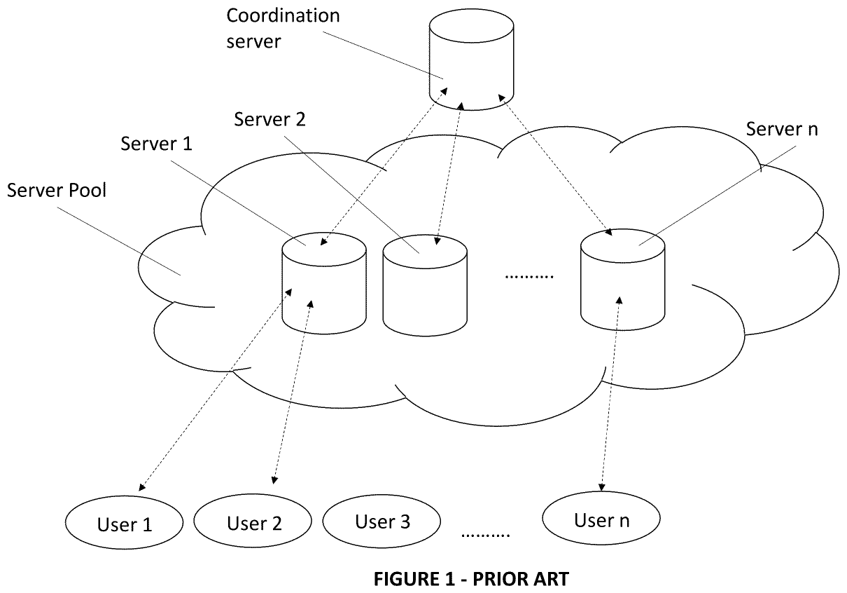

FIG. 2 is a system for updating a server pool;

FIG. 3 depicts example components of a server; and

FIG. 4 is a schematic of a method for updating the servers in a server pool.

### DETAILED DESCRIPTION OF THE INVENTION

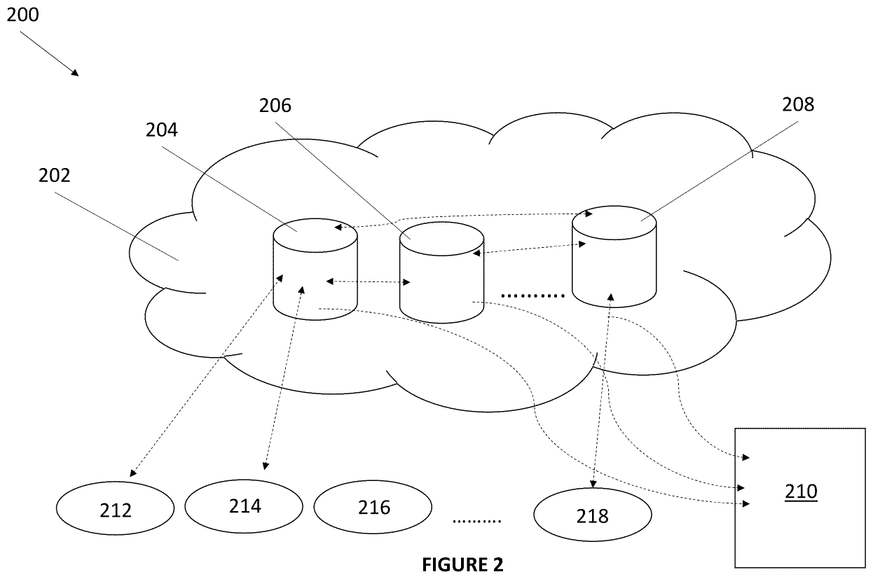

FIG. 2 shows a high-level overview of an example system for distributed coordination for automatic system upgrades. The system 200 comprises a server pool 202 further comprising a plurality of servers 204, 206 and 208. While only 3 servers are depicted in FIG. 2, it can be appreciated that the system and method can be applied to server pools with any number of servers. In the figures, server 204 represents a first server, server 206 represents a second server and server 208 represents and nth server as represented by the dots between the second server 206 and the nth server 208. The servers in the server pool can be connected in communication with each other in any way known to a person skilled in the art. Connections between servers can be created across a local area network (LAN) or wide area network (WAN), by using a pass-through server (a server that acts as an intermediary server between a client and its destination), or over the Internet. The servers are configured to communicate with each other and have access to information about the other servers including, but not limited to, status (online or offline), capacity, and number of users connected to each server. In a preferred embodiment, the servers also have access to the version of binaries or software for each server.

The servers 204, 206 and 208 have access to a manifest 210. The manifest 210 the servers 204, 206 and 208 access the manifest to determine if new binaries are available to them. In a preferred embodiment, the manifest 210 is stored in a cloud, accessible via a HTTP Web request, such as Amazon™ S3 bucket. It can be appreciated that other storage arrangements would be known to a person skilled in the art. The servers each check the manifest at regular intervals. While the frequency of the intervals may change depending on customer preference and application, in the preferred embodiment, the servers check the manifest every hour. In another embodiment, the interval frequency is once per day. In a preferred embodiment, each server in the pool checks the manifest at different times within the interval. In another embodiment, the servers are grouped into a plurality of groups and each group of servers checks the manifest at a different time within the interval. In yet another embodiment, each of the groups of servers checks the manifest at different intervals.

As shown in FIG. 2, a plurality of users 212, 214, 216 and 218 access the server pool. As is known to a person skilled in the art, each user would use a computing device to access the server pool. Examples of such computing devices include, but are not limited to, personal computers, laptops, tablets and mobile devices. These devices can access the server pool in any known fashion including, but not limited to, across a local area network (LAN) or wide area network (WAN), by using a pass-through server or over the Internet. In a similar fashion as the servers, user 212 represents a first user, user 206 represents a second user, user 216 represents a third user and user 218 represents an nth user as represented by the dots between the third user 216 and the nth user 218. The number of users would be limited by the capacity of the server pool.

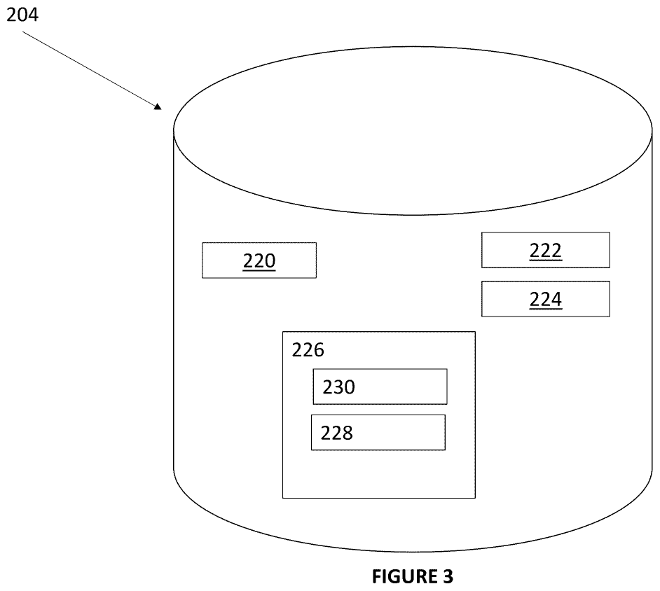

FIG. 3 shows an example embodiment of a server 204. While the first server 204 is used in this example, it can be appreciated that servers 206 and 208 would have similar or identical structure. As shown in FIG. 3, the server 204 can include a processor 220, a volatile memory 222, (for example, but not limited to a Random-Access Memory (RAM)), and a non-volatile memory 224 (for example, a storage device). It is noted that the structure and components of a typical server are generally known to a person skilled in the art, and that the components shown in FIG. 3 is merely for simplification purposes. For example, the server 212 can include additional non-volatile memories 226 (e.g., solid state drives, hard drives, etc.), other processors (e.g., a multi-core central processing unit (CPU)), and the like. The server 212 further includes an operating system (OS) 228 can be loaded at the volatile memory 222, where the OS 228 can be enabled to execute a variety of applications 230 that enable the various techniques described herein to be implemented.

In the preferred embodiment, the servers have at least three modes:
1. Not Running—Offline;
2. Running—Online; and
3. Running—Offline.
When the server is “Not Running—Offline” no users are connected thereto and no users may connect to the server. When a server is “Running—Online”, it accepts new connections and services existing and new connections. In contrast, if a server is “Running—Offline” it does not accept new connections, but does service existing connections.

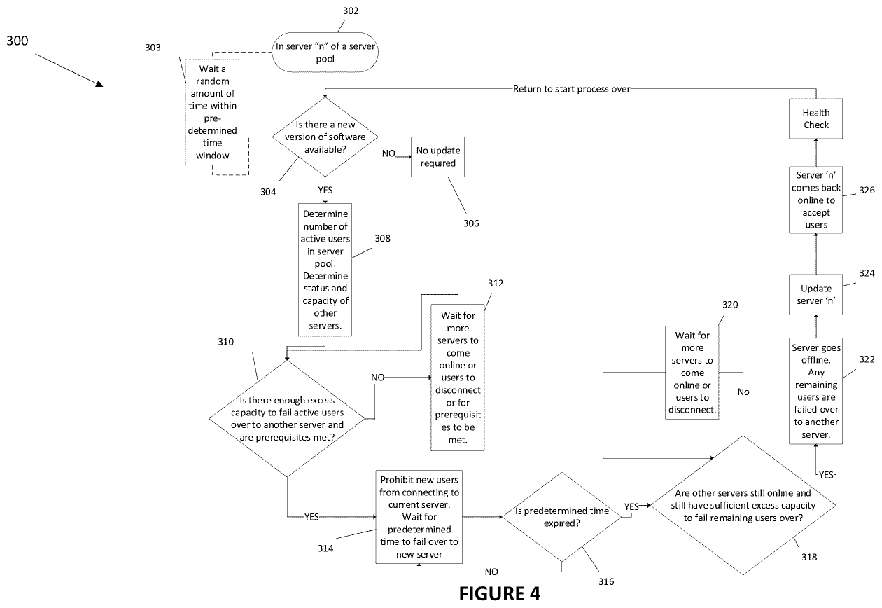

FIG. 4 of the application shows and example embodiment of the method 300 of distributed coordination for automatic system upgrades. The method begins with a server (step 302), called the n^{th} server for simplicity. In the example below, the n^{th} server will be server 204, in the server pool 202. While server 204 is used as an example n^{th} server, it can be appreciated that all any server in the server pool can start the upgrade process and that the upgrade process is followed for all servers in the server pool 202. In the preferred embodiment, the servers are all following the method 300 in parallel. It should further be noted that in another embodiment, if capacity allows, multiple servers could update simultaneously as a group. This is particularly useful if one type of server needs to be updated before a second type of server. In a preferred embodiment, each server waits a random amount of time within a time window to check for any software updates. This prevents the servers from checking for available upgrades at the same time. This option step is shown at 303.

Returning to FIG. 4, the n^{th} server 204, accesses the manifest 210 to determine if there is a new version of software available (step 304). If there is no new version of software available, no update is required (step 306). However, if a new version of the software is available, the n^{th} server determines the number of active users in the server pool 202 (step 308). The n^{th} server further determines the status and associated capacity of the other servers in the server pool 202. In this step, the n^{th} server 204 communicates with the other servers in the server pool 202 to determine if the other servers are running and online. If they are running and online, the capacity of the other servers is determined and an overall capacity of the other servers is calculated. This overall capacity is compared to the number of users connected to the server pool (step 310). If there is not enough capacity for the n^{th} server 204 to fail over any active users, the n^{th} server waits for more servers to come online or for users to disconnect (step 312). If there is enough excess capacity to fail over any active users to another server, the n^{th} server 204 will prohibit new users from connecting thereto (step 314) by entering a running—offline mode. It should be noted that excess capacity refers to how much additional capacity the other servers have in addition to the number of current users. The amount of excess capacity can vary depending on the number of total users with access to the server pool and the server capacity. However, typically, excess capacity takes into account the total capacity of all the servers, a safety margin and the total number of licensees. For example, excess capacity can be calculated as follows:

Excess capacity=(Number of Servers)*(Maximum Capacity per server)*(1+% safety margin)−(Total licensed clients)

where the safety margin depends on the customer and could be, for example, between “capacity to have 1 server offline” up to “capacity for half of the servers to be offline”. Other methods of calculating excess capacity would be known to a person skilled in the art.

For the purposes of this disclosure, capacity of the servers is considered to be a prerequisite. In addition to capacity, other prerequisites can be checked at step 310. For example, in a system with two types of servers, for example database servers and virtual private network (VPN) servers, the order of the updates may be relevant. For example, the database servers may need to be updated before the VPN servers. Thus, at step 310, if a VPN server was attempting to update, it would check to see if the database servers had updated. If they had, the VPN server would continue the method. If the database servers were not updated, the VPN server would wait for this prerequisite to be met (step 312).

In the preferred embodiment, once it is determined that any prerequisites are met and there is capacity in the other servers to allow the n^{th} server to go offline, the n^{th} server waits a predetermined amount of time, for example, 8 hours (step 316). This minimizes the disruption to the end user and allows more users to fail over naturally as opposed to being forced to fail over to another server. Eight hours is used in the preferred embodiment as it aligns with the length of a typical shift or workday and would minimize disruption, it can be appreciated that alternative times would also be effective. Once the predetermined time has expired, the n^{th} server re-checks that the other servers are still online and still have capacity to fail over the remaining users connected to the n^{th} server (step 318). If there is not capacity, the n^{th} server waits for more servers to come online or for users to disconnect (step 320). If there is sufficient excess capacity, the n^{th} server takes itself offline and remaining users connected to the n^{th} server are failed over to one of the other servers (step 322). The n^{th} server is then updated at step 324. Once updated, the n^{th} server comes back online to accept users at step 326.

Once updated, the n^{th} server comes back online, it is preferred that a health check is performed to assess the health of server. The process then continues again from step 304 where the server begins checking for the next update.

In a preferred embodiment, the system monitors a user's use of the server pool to ensure they are not unduly burdened by the server's updates. For example, if a user connected to a server that would like to update was just failed over from another server, the server may wait a predetermined amount of time or until that particular user disconnects before proceeding to upgrade. Furthermore, the system may set time periods in which the servers are preforming their checks for new software and updates. For example, if less users are connected to the server pool at night, the method may only be carried out during these low volume hours.

The system and method described above is adventitious in that the server pool is able to update without the aid of a coordination server making it cost effective and more efficient when compared to traditional systems. Updates are completed without the intervention of humans to initiate the process. Furthermore, the method and system may help to reduce user disruption and eliminates a single point of failure in the upgrade process.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

What is claimed is:

1. A method of automatically updating servers in a network of servers,
said network of servers comprising a plurality of servers configured to communicate with each other;
said method comprising the steps of:
a) a first server of the plurality of servers using a processer to determine if upgrades are available;
b) the first server communicating with the other servers in the plurality of servers to determine if at least one of said other servers are online;
c) the first server querying the other servers to determine if prerequisites are met;
d) if there are other servers online, said first server going offline to install updates;
e) when the update to said first server is complete, said first server returning online; and
repeating steps a to d for each server in said network of servers.

2. The method of claim 1 wherein each server in the network of servers is completing the method in parallel.

3. The method of claim 2 wherein each of the servers in the network of servers waits a random amount of time within a predetermined time window to determine if upgrades are available.

4. The method of claim 3 further comprising before the step of the first server going offline, failing over any users on the first server to a second server in the network of servers.

5. The method of claim 4 wherein a predetermined period of time is passed before failing over any users on the first server to a second server.

6. The method of claim 1 wherein in step c, if other servers are online, new users are prohibited from joining the first server.

7. The method of claim 1 further comprising before the step of the first server going offline, the first server communicating with the plurality servers and receiving the capacity of each server in the network of servers;
the first server calculating the total capacity of the servers in the network by summing the capacity of each server in the network;
comparing the total capacity to the number of active users on the first server;
if the active users on the first servers is less than the total capacity, failing the active users on the first servers over to one of the plurality of servers in the network.

8. The method of claim 2 further comprising before the step of the first server going offline, the first server communicating with the plurality servers and receiving the capacity of each server in the network of servers;
the first server calculating the total capacity of the servers in the network by summing the capacity of each server in the network;
comparing the total capacity to the number of active users on the first server;
if the active users on the first servers is less than the total capacity, failing the active users on the first servers over to one of the plurality of servers in the network.

9. The method of claim 1 wherein the first server is a first block of servers.

10. A server for use in a network of servers comprising:
a server having a communication console configured to communicate with a plurality of servers in the network of servers to send and receive the status, and capacity of each of the plurality of servers, and the program version run by each of the plurality of servers;
said server further comprising a processer to:
access a manifest to determine if new binaries are available;
using the status and capacity of each server in the plurality of servers, determine if there is enough capacity in servers which are online to fail active users on the server over to one or more of the plurality of servers;
the processer failing over the active users to one or more of the plurality of servers;
the processer taking the server offline and updating the binaries;
when the update to said server is complete, said processor returning the server to an online status.

11. A network of servers comprising
said plurality of servers connected in a network of servers, each having a communication console configured to communicate with the plurality of servers in the network of servers to send and receive the status, and capacity of each of the plurality of servers, and the program version run by each of the plurality of servers;
each of said plurality of servers further comprising a processer to:
access a manifest to determine if new binaries are available;
using the status and capacity of each server in the plurality of servers, determine if there is enough capacity in servers which are online to fail active users on the server over to one or more of the plurality of servers;
the processer failing over the active users to one or more of the plurality of servers;
the processer taking the server offline and updating the binaries;
when the update to said server is complete, said processor returning the server to an online status.
